(19) United States
(12) Patent Application Publication
(10) Pub. No.: US 2021/0298390 A1
(43) Pub. Date: Sep. 30, 2021

(54) PROTECTIVE MASK

(71) Applicant: University of Massachusetts, Boston, MA (US)

(72) Inventors: Frank Charles Sup, IV, Amherst, MA (US); Meghan Elizabeth Huber, Sunderland, MA (US); David Junichi Follette, Amherst, MA (US)

(21) Appl. No.: 17/301,144

(22) Filed: Mar. 26, 2021

Related U.S. Application Data
(60) Provisional application No. 63/000,281, filed on Mar. 26, 2020.

(51) Int. Cl. A41D 13/11; B29C 64/188

(52) U.S. Cl. CPC A41D 13/1184; B33Y 80/00; B29C 64/188; A41D 13/1161

(57) ABSTRACT

The present disclosure can include a protective mask made of a monolithic piece of material. The mask can have a shield portion with a top portion and a bottom portion, the shield portion configured to protect from contaminants, a strap portion extending from the shield portion, the strap portion configured to be secured around a circumference, and a fold line extending laterally across the shield portion, the fold line near the top of the shield portion, wherein the monolithic piece is configured to be folded along the fold line to provide a curvature. A method of making a mask can include shaping a monolithic piece of material into a mask shape having a shield portion for protection, a strap portion for securing the shield portion, and a folding line on the shield portion for creating a curvature along a top portion of the shield portion.

### PRIORITY APPLICATION

This application claims priority to U.S. Provisional Application Ser. No. 63/000,281, filed Mar. 26, 2020, the disclosure of which is incorporated herein in its entirety by reference.

### BACKGROUND

The healthcare industry relies on protective equipment such as gowns, gloves, googles, and masks to protect their professionals, such as a nurses and doctors. Likewise, scientific, engineering, and technology industries rely on protective gear for scientists and engineers in the laboratory. Specifically, face masks or shields can protect a user's face from hazards such as infectious materials in medical and laboratory environments, or chemical splashes in industry or laboratory environments.

In the wake of the 2020 global pandemic of the coronavirus outbreak resulting in a large number of COVID-19 cases, these industries are short on protective supplies and gear. With the airborne nature of the coronavirus causing COVID-19, healthcare, scientific, and technical industries and low on protective masks for their workers.

### SUMMARY OF THE DISCLOSURE

The present disclosure provides a protective face mask that can be used, for example, in medical or laboratory settings. The mask can include on monolithic piece of a plastic or polymer material suitable for preventing transfer of airborne microorganisms to the face of the user. The mask can be made, for example, by laser cutting or by additive manufacturing so that there are no seams or joints in the mask.

The mask can include a shield portion and a head wrap portion, the head wrap portion near the top of the shield portion and extending in either direction so as to allow wrapping of the head portion around the circumference of a user's head. The top of the shield portion can be folded down to a suitable size so that the mask presses in a curved fashion against the user's forehead when applied.

The disclosed masks can be quickly and easily reproduced by manufacturing methods such as laser cutting, additive manufacturing, or other methods allowing for a monolithic piece to be cut into a mask and used. Moreover, the monolithic nature of the masks can allow for little or no seams or joints, and less breakage over time.

In an example, a protective mask can include a monolithic piece of material. The monolithic piece of material can include a shield portion, a strap portion, and a fold line. The shield portion can include a top portion and bottom portion, and be configured to provide protection from contaminants. The strap portion can extend from the shield portion near the top portion, the strap portion can be configured to be secured around a circumference. The fold line can extend laterally along the shield portion, near the top portion. The monolithic piece can be folded along the fold line to provide a curvature.

In a second example, a protective mask can include a monolithic piece of material. The monolithic piece of material can include a shield portion, a strap portion, and a folded portion. The shield portion can have a top portion and bottom portion. The shield portion can be configured to protect a user from contaminants. The strap portion can extend from the shield portion in two opposing directions near the top portion. The strap portion can be configured to be secured around a circumference of a head. The folded portion can extend laterally along the top portion for positioning of a forehead therein.

In a third example, a method of making a protective mask can include shaping a monolithic piece of material into a mask shape having a shield portion for protection, a strap portion for securing the shield portion, and a folding line on the shield portion for creating a curvature along a top portion of the shield portion.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic diagram of a protective mask in an example.

FIGS. 2A-2B are photographs depicting a protective mask in an example.

FIGS. 3A-3C are photographs depicting a protective mask in an example.

FIG. 4 depicts a flow chart depicting a method of making a protective mask in an example.

### DETAILED DESCRIPTION

The present disclosure describes, among other things, a protective mask and method of making the same. The disclosed monolithic mask only requires one source material, reducing the time required to obtain the required materials for manufacturing. Thus, the monolithic mask can be created in one piece in a rapid production line, such as for emergency situations. The mask can additionally cover the user face, including eyes, nose, and mouth, and the sides of the faces up to the ears. The mask can be adjustable so that users of varying head circumference can use a mask printed or shaped based on the same original pattern.

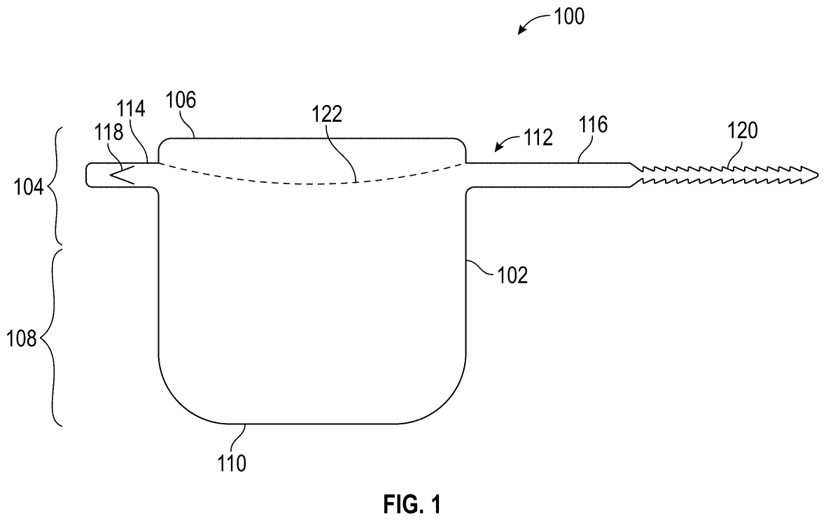

FIG. 1 illustrates a schematic diagram of a protective mask 100 in an example. The mask 100 can include a shield portion 102 with a top portion 104, top side 106, a bottom portion 108, and bottom side 110, a strap portion 112 with a first side 114 and second side 116, end portions 118, 120, and fold line 122.

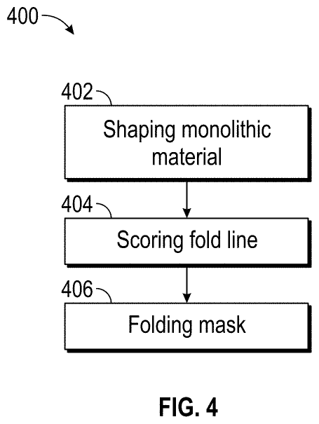

The protective mask 100 can be made of a monolithic material. The material can be flexible and clear (e.g., see-through) to allow comfort and visibility. The material can be light weight, thin, and foldable. The material can be, for example, a plastic or other polymer, a polycarbonate, a cellulose acetate, or other suitable material. The material can be a monolithic piece, created by a method as discussed below with reference to FIG. 4. The method can include a step of shaping the material, such as by laser cutting or additive manufacturing, so that the piece is monolithic, and does not contain joints, junctures, or other weak points at joining of material. The protective mask 100 can have a depth of about 8″ to 12″, about 9″ to 11″, or about 10″.

The shield portion 102 can, when the protective mask is in use, protect a user's face from contaminants. The shield portion 102 can be rectangular, oval, or a combination thereof, such that the shield portion effectively separates the user's face from the surrounding environment. The shield portion 102 can protect the user from contaminants such as fluids, gases, or liquids, that may be or may contain particles, chemicals, microbes, debris, particulates, or other contaminants not desired to come into contact with the user's face for health and safety reasons.

In the example if FIG. 1, the shield portion 102 can have a generally rectangular shape, or a generally oval shape. The shield portion 102 can have a top portion 104 with a flat top side 106. In some cases, the top side 106 can be curve or angled. The shield portion 102 can have a bottom portion 108 and bottom side 110. The bottom side 110 can be flat, curved, angled, or a combination thereof. The bottom side 110 can be smooth or rounded so as to prevent sharp corners that could rip or tear other protective equipment, such as gowns.

The strap portion 112 is part of the same monolithic material as the shield portion 102. The strap portion 112 can be for securing the mask 100 to a user's head. In mask 100 of FIG. 1, the strap portion 112 can have a first side 114 and second side 116, each extending laterally from the top portion 104 of the shield portion 102. In some cases, the strap portion 112 can extend from one side of the mask 100. The strap portion 112 can extend, for example, about 20″ to 40″, or about 25″ to about 35″, or about 27″ to 32″.

In the strap portion 112 in FIG. 1 can have end portions 118, 120 on first and second side portions 114, 116, respectively. End portion 118 and end portion 120 can be sized, shaped, or arranged, such that they can clasp, mate, or fasten together to secure the strap portion 112 around a user's head. In mask 100, the first end portion 118 can include a slot for receiving the second end portion 120. The second end portion 120 can have a triangular or other type of tab that fits into the slot of the first end portion 118. In some cases, the second end portion 120 can have multiple tabs or shapes to allow for adjustable sizing.

The fold line 122 can be an indentation or etching extending laterally along the top portion 104 of the shield portion 102. The fold line 122 can be curved so that when folding is accomplished, the curve of the top of the mask 100 fits snuggly against a user's forehead. The fold line 122 can allow for easy bending of the monolithic material along the contours of the fold line 122, such as folding a part of the top portion 104 of the shield down towards the inside of the mask. The resulting folded section can press up against the user's forehead when in use to allow for a secure connection. The fold line 122 can be, for example, a dashed cut line or a solid score line.

The fold line 122 can be, for example, etching of a dashed line, or a thing score along the lateral length of the material, to allow easy bending. Additional etchings may be included on the monolithic material, such as the work “BEND” on or near the fold line 122 to provide user instruction. Additionally, etchings may be provided on the monolithic material such as “FRONT” and “BACK” for each understanding. In some cases, etchings may be provided on the strap portion 112 such as “INSERT” such as for the end portion 120 containing a securement mechanism.

The mask 100 herein can optionally be modified by the addition of other materials, such as a foam forehead piece, or an elastic piece around the strap portion 112, but can be used sufficiently without those additional materials and pieces. This could be done, for example, in a clinical or laboratory setting if the user desired to further modify the mask.

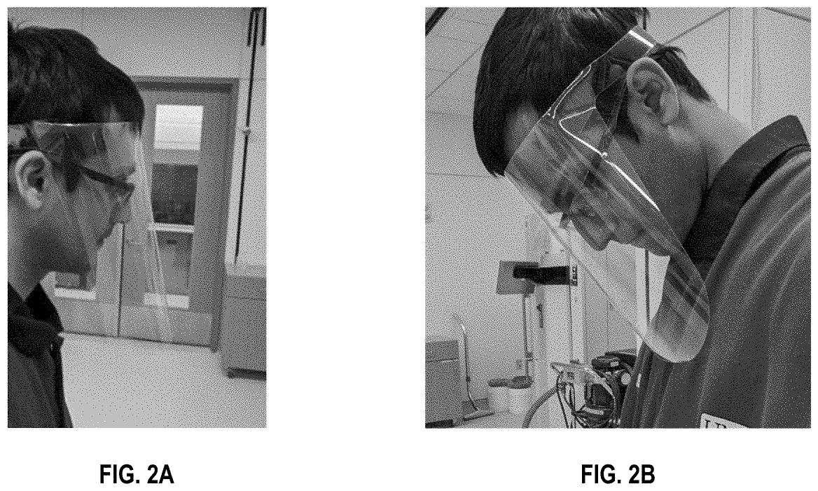

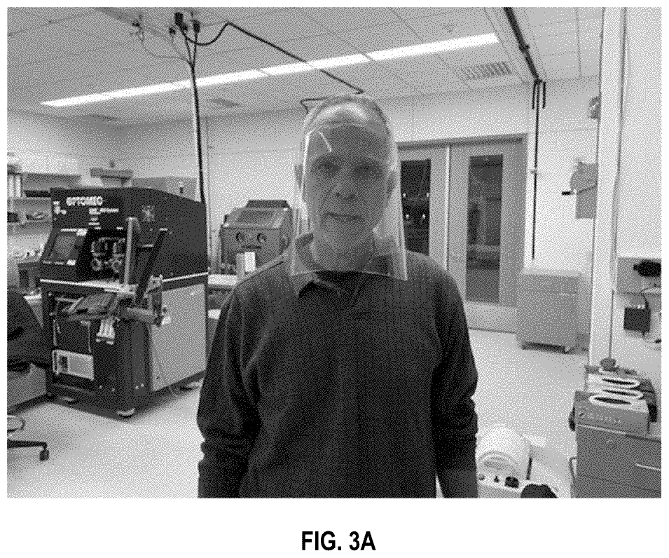

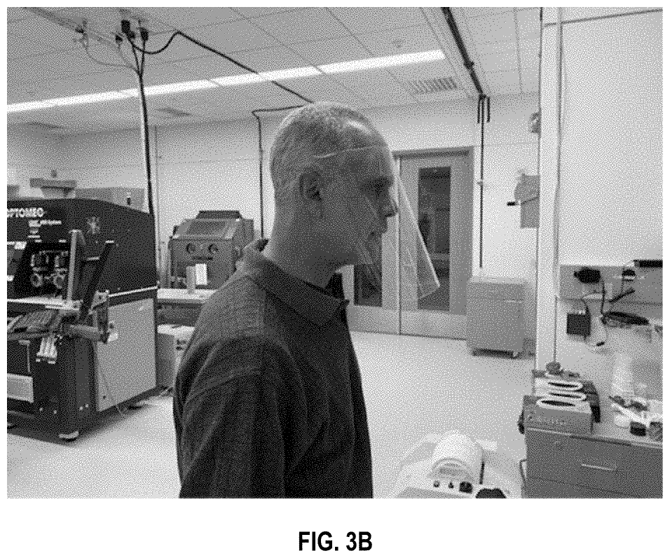

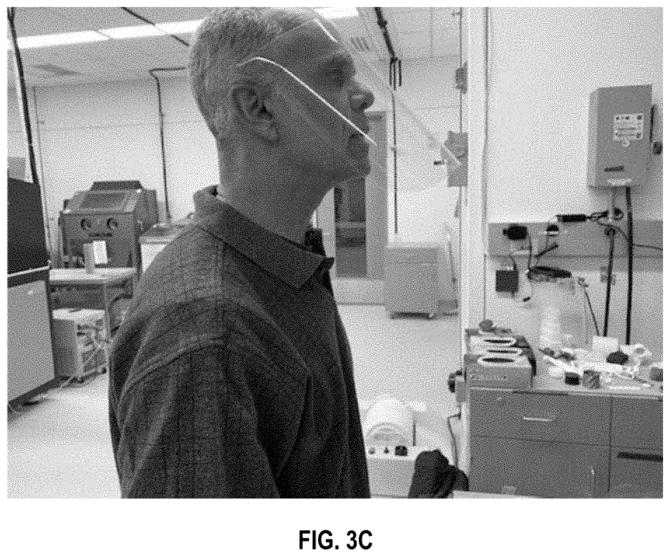

FIGS. 2A-2B are photographs depicting a protective mask in an example, and FIGS. 3A-3C are photographs depicting a protective mask in an example. FIGS. 2A-2B and 3A-3C will be discussed together. In FIGS. 2A-2B and 3A-3C, an example mask, such as mask 100, is shown in use on a user.

Here, the mask is folded along the fold line to provide a curvature in which a user can place his or her forehead. The strap portion is wrapped around the circumference of the user's head and secured snuggly with a fastened. FIGS. 2A-2B and 3B-3C show side views of the example mask in use, and FIG. 3A shows a front view of the example mask in use.

When in use, the mask can fit tightly against the user's forehead due in part to the folded line curvature. The material of the mask can be flexible enough to conform to the size of the user's head, but also stiff enough to provide a sturdy shield in front of the user's face to prevent transfer of contaminants therethrough.

Shown in the front view of FIG. 3A, the mask can fall several inches past the chin of the user, but extend outward enough to allow head nodding and movement. The eyes, noses, and mouth of the user can be covered and shielded by the shield portion of the mask. As seen in the side views of FIGS. 2A-2B and 3B-3C, the mask can come up to the ears of the user. This can allow for more full coverage along the sides of the user's face, including cheekbones and temples, as opposed to only the front portion of a user's face.

FIG. 4 depicts a flow chart depicting a method 400 of making a protective mask in an example. Method 400 can include the steps of shaping a monolithic material (step 402), scoring a fold line thereon (step 404), and folding the mask into place before use (step 406).

In the first step 402, the mask can be shaped from a monolithic material. For example, the mask can be shaped to have a shield portion and a strap portion as shown and discussed with reference to FIGS. 1-3C above. The material can be, for example, laser cut, additive manufactured, or shaped by another method that does not create joints in the material. Other methods can include, for example, die cutting and thermomoulding, sheet cutting, using a router, or other methods.

The material can be, for example, a plastic that is thin and flexible but also holds a curvature, such as a polyurethane film, an acetate film, or other suitable material. The material can be clear so that the user can see through it when the mask is in use.

In some cases, the shield portion can be rounded or smoothed such that there are no sharp corners on the mask. In some cases, the strap portion can be further shaped to create end portions that can join together as a fastened. In some cases, the strap portion can be made such that the fastener is adjustable for various head circumferences.

In the second step, the fold line can be created on the material, such as near the top of the shield portion. The fold line can be etched or scored into the material, such as in a thin scored line or in a dashed line, to allow for easy bending of the material. The fold line can be curved to allow for shaping of the forehead. At this point, the mask can, for example, be shipped out for use.

When a user is ready to use the mask, they can fold the mask along the fold line (step 406), and place the curvature of the mask against their forehead. The user can fasten the strap portion behind their head.

### VARIOUS NOTES & EXAMPLES

Example 1 can include a protective mask can include a monolithic piece of material. The monolithic piece of material can include a shield portion, a strap portion, and a fold line. The shield portion can include a top portion and bottom portion, and be configured to provide protection from contaminants. The strap portion can extend from the shield portion near the top portion, the strap portion can be configured to be secured around a circumference. The fold line can extend laterally along the shield portion, near the top portion. The monolithic piece can be folded along the fold line to provide a curvature.

Example 2 can include Examples 1, wherein the protective mask is laser-cut or additively manufactured.

Example 3 can include any of Examples 1-2, wherein the strap portion extends from the shield portion in two opposing directions.

Example 4 can include any of Examples 1-3, wherein the strap portion further comprises two end portions.

Example 5 can include any of Examples 1-4, wherein each of the end portions are configured to be secured to each other.

Example 6 can include any of Examples 1-5, wherein the fold line is curved along the shield portion.

Example 7 can include any of Examples 1-6, wherein the fold line is aligned with the strap portion.

Example 8 can include any of Examples 1-7, wherein the top portion of the shield portion comprises a top edges that is flat.

Example 9 can include any of Examples 1-9, wherein the bottom portion of the shield portion comprises a bottom edges that is curved.

Example 10 can include a protective mask can include a monolithic piece of material. The monolithic piece of material can include a shield portion, a strap portion, and a folded portion. The shield portion can have a top portion and bottom portion. The shield portion can be configured to protect a user from contaminants. The strap portion can extend from the shield portion in two opposing directions near the top portion. The strap portion can be configured to be secured around a circumference of a head. The folded portion can extend laterally along the top portion for positioning of a forehead therein.

Example 11 can include a method of making a protective mask can include shaping a monolithic piece of material into a mask shape having a shield portion for protection, a strap portion for securing the shield portion, and a folding line on the shield portion for creating a curvature along a top portion of the shield portion.

Example 12 can include Example 11, wherein shaping a monolithic piece of material comprises laser cutting the material.

Example 13 can include any of Examples 11-12, wherein shaping a monolithic piece of material comprises additively manufacturing the material.

Example 14 can include any of Examples 11-13, wherein the monolithic piece of material comprises a plastic.

Example 15 can include any of Examples 11-14, wherein the monolithic piece of material comprises a see-through material.

Example 16 can include any of Examples 11-15, further comprising folding the monolithic piece of material along the fold line to create a curvature

Example 17 can include any of Examples 11-16, further comprising shaping the strap portion to create a fastening mechanism on either end of the strap portion.

Example 18 can include any of Examples 11-17, wherein the mask shape is sized for application to an adult.

Example 19 can include any of Examples 11-18, wherein the mask shape is sized for application to a child.

Example 20 can include protective mask made by the method of Example 11.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A protective mask comprising:
a monolithic piece of material comprising:
a shield portion having a top portion and a bottom portion, the shield portion configured to protect from contaminants;
a strap portion extending from the shield portion near the top portion, the strap portion configured to be secured around a circumference; and
a fold line extending laterally across the shield portion, the fold line near the top of the shield portion,
wherein the monolithic piece is configured to be folded along the fold line to provide a curvature.

2. The protective mask of claim 1, wherein the monolithic piece of material is laser-cut or additively manufactured.

3. The protective mask of claim 1, wherein the strap portion extends from the shield portion in two opposing directions.

4. The protective mask of claim 3, wherein the strap portion further comprises two end portions.

5. The protective mask of claim 4, wherein each of the end portions are configured to be secured to each other.

6. The protective mask of claim 1, wherein the fold line is curved along the shield portion.

7. The protective mask of claim 1, wherein the fold line is aligned with the strap portion.

8. The protective mask of claim 1, wherein the top portion of the shield portion comprises a top edge that is flat or rounded.

9. The protective mask of claim 1, wherein the bottom portion of the shield portion comprises a bottom edges that is curved or rounded.

10. A protective mask comprising:
a monolithic piece of material comprising:
a shield portion having a top and a bottom, the shield portion configured to protect a user from airborne contaminants;
a strap portion extending in from the shield portion in two opposing directions near the top portion, the strap portion configured to be secured around a circumference of a head; and
a folded portion extending laterally across the top of the shield portion for positioning of a forehead therein.

11. A method of making a protective mask, comprising:
shaping a monolithic piece of material into a mask shape having a shield portion for protection, a strap portion for securing the shield portion, and a folding line on the shield portion for creating a curvature along a top portion of the shield portion.

12. The method of claim 11, wherein shaping a monolithic piece of material comprises laser cutting the material.

13. The method of claim 11, wherein shaping a monolithic piece of material comprises additively manufacturing the material.

14. The method of claim 11, wherein the monolithic piece of material comprises a plastic.

15. The method of claim 11, wherein the monolithic piece of material comprises a see-through material.

16. The method of claim 11, further comprising folding the monolithic piece of material along the fold line to create a curvature

17. The method of claim 11, further comprising shaping the strap portion to create a fastening mechanism on either end of the strap portion.

18. The method of claim 11, wherein the mask shape is sized for application to an adult.

19. The method of claim 11, wherein the mask shape is sized for application to a child.

20. A protective mask made by the method of claim 11.
